(19) United States
(12) Patent Application Publication
(10) Pub. No.: US 2020/0047562 A1
(43) Pub. Date: Feb. 13, 2020

(54) Pneumatic Tire

(71) Applicant: The Yokohama Rubber Co., LTD., 36-11, Shimbashi 5-chome (JP)

(72) Inventor: Masayuki NEMOTO, Hiratsuka-shi, Kanagawa (JP)

(73) Assignee: The Yokohama Rubber Co., LTD., 36-11, Shimbashi 5-chome (JP)

(21) Appl. No.: 16/605,783

(22) PCT Filed: Feb. 16, 2018
(86) PCT No.: PCT/JP2018/005574

§ 371 Date: Oct. 16, 2019

(30) Foreign Application Priority Data
Apr. 17, 2017 (JP) 2017-081647

(51) Int. Cl. B60C 15/06; B60C 9/00; B60C 11/00

(52) U.S. Cl. CPC B60C 15/0628; B60C 9/0007; B60C 11/005; B60C 11/0008; B60C 2013/006; B60C 2015/0678; B60C 2015/065; B60C 2015/0682; B60C 2009/0071

(57) ABSTRACT

A pneumatic tire includes one carcass including a folded up portion and a reinforcing layer between the folded up portion and a bead filler. The folded up portion has an end portion in a region inward of a belt layer in a radial direction and inward of the belt layer in a lateral direction. The bead filler has an outer end portion distanced from a bead heel portion from 20% or more to 40% or less of a tire cross-sectional height. The reinforcing layer has an outer end portion outward of the outer end portion of the bead filler in the radial direction and inward in the radial direction with respect to a position of a tire maximum width position in the radial direction. A sidewall portion is formed of a side rubber having tan δ at 60° C. of from 0.04 or more to 0.10 or less.

### TECHNICAL FIELD

The present technology relates to a pneumatic tire.

### BACKGROUND ART

Since various performances such as steering stability are required for pneumatic tires, structures of conventional pneumatic tires have been variously devised to meet these requirements. For example, in Japan Patent No. 4437845 and Japan Unexamined Patent Publication No. 2001-341506, folded up portions when a carcass is wound around a bead core are extended outward in a tire radial direction and are overlapped with both end portions of a belt to terminate, or folded up ends are disposed near a belt layer, thus ensuring steering stability and improving durability. In Japan Unexamined Patent Publication No. H10-024712, a hard rubber layer and a soft rubber layer are disposed outside a folded back portion of a carcass ply to improve durability of a bead portion without an increase in tire weight.

Additionally, in Japan Unexamined Patent Publication No. 2016-043886, first and second carcass plies are provided. An end portion of a part folded back outside in the first carcass ply is located inside a belt, and a side reinforcing layer is disposed outward of a bead filler in a tire lateral direction, thus ensuring durability and steering stability. Further, in Japan Unexamined Patent Publication No. 2004-352174, two carcass plies are provided, one carcass ply has an outer end of a folded up portion located further inward in a tire axial direction than an outer end of a belt layer in the tire axial direction, and a cord reinforcing layer, which extends in a tire radial direction along a bead apex, is disposed in a bead portion. Thus, even in use under a situation of low load factor, high steering stability can be exhibited.

Fuel economy of vehicles has been recently regarded as important. In accordance with this, light weight and reduction in rolling resistance have been requested for pneumatic tires. For light weight, it is only required that members constituting the pneumatic tire are reduced. For example, the use of one carcass ensures light weight. However, since the use of one carcass results in a decrease in rigidity, steering stability is possibly deteriorated. An example of a method for enhancing steering stability as much as possible includes increasing hardness of a base rubber of a tread portion. However, the increase in the hardness of the base rubber possibly increases rolling resistance, thus possibly failing to ensure performances required for the pneumatic tires. Thus, achieving light weight and reduction in rolling resistance without deteriorating steering stability was extremely difficult.

### SUMMARY

The present technology provides a pneumatic tire that allows improving steering stability while achieving light mass and reduction in rolling resistance. A pneumatic tire according to the present technology includes a belt layer, a pair of sidewall portions, a pair of bead portions, bead fillers, one carcass, and a reinforcing layer. The belt layer is disposed inward of a tread portion in a tire radial direction. The pair of sidewall portions are disposed on both sides of a tire equatorial plane in a tire lateral direction. The pair of bead portions are disposed inward of the pair of the sidewall portions in the tire lateral direction. The pair of bead portions include bead cores formed into annular shapes. The bead fillers are disposed outward of the bead cores in the tire radial direction. The one carcass is disposed across the pair of bead portions. The one carcass has a folded up portion. The folded up portion is folded back outward of the bead core in the tire lateral direction from inward in the tire lateral direction. The reinforcing layer is disposed between the folded up portion of the carcass and the bead filler. The folded up portion of the carcass has an end portion disposed in a region inward of the belt layer in the tire radial direction and inward of the belt layer in the tire lateral direction. The bead fillers have outer end portions in the tire radial direction having a distance from bead heel portions of the bead portions in a range from 20% or more to 40% or less of a tire cross-sectional height. The reinforcing layer has an outer end portion in the tire radial direction located further outward in the tire radial direction than the outer end portion of the bead filler in the tire radial direction and further inward in the tire radial direction than a position of a tire maximum width position in the tire radial direction. The reinforcing layer has an inner end portion in the tire radial direction located further outward than the bead core in the tire radial direction. The sidewall portions are made of a side rubber having tan δ at 60° C. in a range from 0.04 or more to 0.10 or less.

In the pneumatic tire described above, preferably, in the reinforcing layer, the outer end portion of the reinforcing layer has a distance from the outer end portion of the bead filler in a range from 5 mm or more to 15 mm or less.

The pneumatic tire described above is preferably configured as follows. The reinforcing layer includes a reinforcing cord made of a steel. The reinforcing cord has a wire diameter in a range from 0.20 mm or more to 0.30 mm or less. The reinforcing cord in the reinforcing layer has a cord count per 50 mm in a range from 35 or more to 45 or less.

The pneumatic tire described above is preferably configured as follows. The reinforcing layer is made of a rubber. The rubber has JIS (Japanese Industrial Standard) hardness at 20° C. in a range from 85 or more to 95 or less and tan δ at 60° C. in a range from 0.12 or more to 0.20 or less.

In the pneumatic tire described above, preferably the bead filler has a cross-sectional area in a meridian cross-section of the pneumatic tire in a range from 110 mm² or more to 160 mm² or less.

The pneumatic tire described above is preferably configured as follows. The tread portion includes a cap rubber forming a tread surface and a base rubber. The base rubber is located inward of the cap rubber in the tire radial direction. The base rubber has JIS hardness at 20° C. in a range from 75 or more to 81 or less and tan δ at 60° C. in a range from 0.14 or more to 0.22 or less.

In the pneumatic tire described above, preferably the side rubber has a minimum value Dm of a thickness in a range of 1.0 mm≤Dm≤3.5 mm.

The pneumatic tire described above is preferably configured as follows. Between the side rubber or a rim cushion rubber and the folded up portion of the carcass, a side reinforcing layer is disposed. The side reinforcing layer is made of a rubber having JIS hardness at 20° C. in a range from 70 or more to 85 or less and tan δ at 60° C. in a range from 0.06 or more to 0.12 or less. The side reinforcing layer is formed at a thickness in a range from 0.5 mm or more to 2.0 mm or less. The side reinforcing layer is disposed at a position including the tire maximum width position.

The pneumatic tire described above is preferably configured as follows. The tire cross-sectional height is in a range from 110 mm or more to 170 mm or less. An aspect ratio is 55 or more.

The pneumatic tire according to embodiments of the present technology has an effect that allows improving steering stability while achieving light mass and reduction in rolling resistance.

### BRIEF DESCRIPTION OF DRAWINGS

FIG. 1 is a meridian cross-sectional view illustrating a main portion of a pneumatic tire according to an embodiment.

FIG. 2 is a detailed view of A of FIG. 1.

FIG. 3 is a detailed view of B of FIG. 1.

FIG. 4 is an explanatory diagram of a carcass and a reinforcing layer as viewed in a C-C direction of FIG. 3.

FIG. 5 is a view taken along line D-D of FIG. 4 in the direction of the arrows.

FIG. 6 is a modified example of the pneumatic tire according to the embodiment and an explanatory diagram of a side reinforcing layer.

FIG. 7 is a modified example of the pneumatic tire according to the embodiment and an explanatory diagram of the side reinforcing layer.

FIG. 8 is a modified example of the pneumatic tire according to the embodiment and an explanatory diagram of the side reinforcing layer.

FIG. 9A is a table describing results of performance tests of pneumatic tires.

FIG. 9B is a table describing results of performance tests of pneumatic tires.

FIG. 9C is a table describing results of performance tests of pneumatic tires.

FIG. 9D is a table describing results of performance tests of pneumatic tires.

### DETAILED DESCRIPTION

Pneumatic tires according to embodiments of the present technology are described in detail below with reference to the drawings. However, the present technology is not limited by the embodiment. Components of the following embodiments include components that are substantially identical or that can be substituted or easily conceived by one skilled in the art.

Herein, “tire radial direction” refers to the direction orthogonal to a rotation axis of a pneumatic tire 1. “Inward in the tire radial direction” refers to the side toward the rotation axis in the tire radial direction. “Outward in the tire radial direction” refers to the side away from the rotation axis in the tire radial direction. “Tire circumferential direction” refers to the circumferential direction with the rotation axis as the center axis. Additionally, “tire lateral direction” refers to the direction parallel with the rotation axis. “Inward in the tire lateral direction” refers to the side toward a tire equatorial plane (tire equator line) CL in the tire lateral direction. “Outward in the tire lateral direction” refers to the side away from the tire equatorial plane CL in the tire lateral direction. “Tire equatorial plane CL” refers to the plane orthogonal to the rotation axis of the pneumatic tire 1 that passes through the center of the tire width of the pneumatic tire 1. “Tire width” is the width in the tire lateral direction between components located outward in the tire lateral direction, or in other words, the distance between the components that are the most distant from the tire equatorial plane CL in the tire lateral direction. “Tire equator line” refers to the line in the tire circumferential direction of the pneumatic tire 1 that lies on the tire equatorial plane CL.

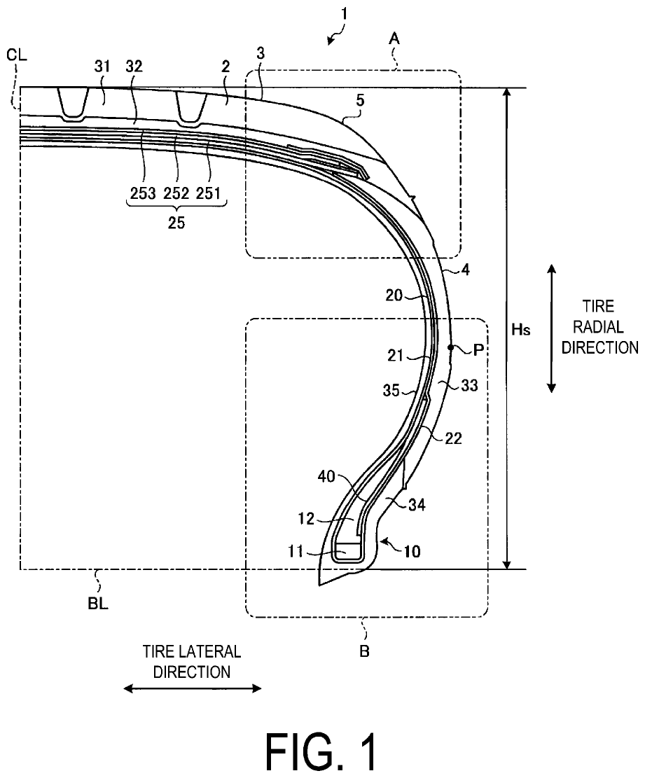

FIG. 1 is a meridian cross-sectional view illustrating a main portion of the pneumatic tire 1 according to an embodiment. The pneumatic tire 1 illustrated in FIG. 1 as viewed in a meridian cross-section is provided with a tread portion 2 in the outermost portion in the tire radial direction. The tread portion 2 has an outer circumferential surface constituting a profile of the pneumatic tire 1. The outer circumferential surface of the tread portion 2 is a surface that comes into contact with a road surface while a vehicle to which the pneumatic tires 1 are mounted is running, thus formed as a tread surface 3. A plurality of grooves such as circumferential main grooves (not illustrated) extending in the tire circumferential direction and lug grooves (not illustrated) extending in the tire lateral direction are formed in the tread surface 3.

The tread portion 2 includes a cap rubber 31 that forms the tread surface 3, and a base rubber 32 located inward of the cap rubber 31 in the tire radial direction. In other words, the tread portion 2 is configured by layering the cap rubber 31 and the base rubber 32 in the tire radial direction. The cap rubber 31 and the base rubber 32 differ from one another in rubber. That is, the cap rubber 31 and the base rubber 32 differ from one another in rubber hardness. Specifically, the cap rubber 31 is made of a rubber having JIS hardness at 20° C. in a range from 62 or more to 68 or less, and the base rubber 32 is made of a rubber having JIS hardness at 20° C. in a range from 75 or more to 81 or less. Furthermore, the cap rubber 31 and the base rubber 32 differ in visco-elasticity. While the cap rubber 31 has a tan δ at 60° C. in a range from 0.08 or more to 0.16 or less, the base rubber 32 has a tan δ at 60° C. in a range from 0.14 or more to 0.22 or less.

In the present embodiment, JIS hardness at 20° C. refers to rubber hardness indicated by JIS-A hardness compliant with JIS K6253 measured at 20° C. In the present embodiment, “tan δ at 60° C.” refers to a value measured compliant with JIS K6394 using a viscoelasticity spectrometer (available from Toyo Seiki Seisaku-sho, Ltd.) with conditions: temperature of 60° C.; frequency of 20 Hz; static distortion of 10%; and dynamic distortion of ±2%.

Shoulder portions 5 are located on both ends of the tread portion 2 in the tire lateral direction. Sidewall portions 4 formed from side rubbers 33 are disposed inward of the shoulder portions 5 in the tire radial direction. In other words, the two sidewall portions 4 are disposed on both sides of the pneumatic tire 1 in the tire lateral direction. That is, a pair of the sidewall portions 4 are disposed on both sides of the tire equatorial plane CL in the tire lateral direction. The side rubber 33 constituting the sidewall portion 4 is made of a rubber having JIS hardness at 20° C. in a range from 50 or more to 54 or less and a tan δ at 60° C. in a range from 0.04 or more to 0.10 or less. Note that the tan δ of the side rubber 33 at 60° C. is preferably in a range from 0.05 or more to 0.11 or less.

In the sidewall portion 4, the side rubber 33 is formed so as to have a thickness with a minimum value Dm in a range of 1.0 mm≤Dm≤3.5 mm. The minimum value Dm of the thickness of the side rubber 33 is the thickness of the side rubber 33 at a position where the thickness of the side rubber 33 becomes the thinnest between a tire maximum width position P and a position of an end portion 251a of a cross belt 251. The tire maximum width position P in this case is a position in the tire radial direction where a dimension in the tire lateral direction excluding structures protruding from the surfaces of the sidewall portions 4 becomes the maximum when the pneumatic tire 1 is mounted on a specified rim, specified internal pressure is inflated, and a load is not applied to the pneumatic tire 1, an unloaded state.

Note that “specified rim” here refers to an “applicable rim” defined by the Japan Automobile Tyre Manufacturers Association Inc. (JATMA), a “Design Rim” defined by the Tire and Rim Association, Inc. (TRA), or a “Measuring Rim” defined by the European Tyre and Rim Technical Organization (ETRTO). Additionally, a rim base line BL here refers to a tire axial direction line passing through a rim diameter defined by the standard of JATMA. Additionally, “specified internal pressure” refers to a “maximum air pressure” defined by JATMA, to the maximum value in “TIRE LOAD LIMITS AT VARIOUS COLD INFLATION PRESSURES” defined by TRA, or to “INFLATION PRESSURES” defined by ETRTO.

Bead portions 10 are disposed inward of the pair of sidewall portions 4, which are located on both sides in the tire lateral direction, in the tire radial direction. Similarly to the sidewall portions 4, the two bead portions 10 are disposed on both sides of the tire equatorial plane CL. That is, a pair of the bead portions 10 are disposed on both sides of the tire equatorial plane CL in the tire lateral direction. The bead portions 10 are each provided with a bead core 11, and a bead filler 12 is provided outward of the bead core 11 in the tire radial direction. The bead core 11 is an annular member formed into an annular shape formed by bundling a plurality of bead wires, and the bead filler 12 is a rubber member disposed outward of the bead core 11 in the tire radial direction.

A belt layer 25 is disposed inward of the tread portion 2 in the tire radial direction. The belt layer 25 is disposed by layering a plurality of cross belts 251 and 252 and a belt cover 253. Among these members, the cross belts 251 and 252 are configured by coating a plurality of belt cords made of steel or an organic fiber material with coating rubber and performing a rolling process on the belt cords, and have belt angles from 20° or more to 55° or less as absolute values. Furthermore, the plurality of cross belts 251 and 252 differ in belt angle, which is defined as an inclination angle of the belt cord in a fiber direction with respect to the tire circumferential direction, from one another, thus configured as a so-called crossply structure in which the plurality of cross belts 251 and 252 are layered having the fiber directions of the belt cords intersecting with one another. The belt cover 253 is configured by performing a rolling process on one or a plurality of cords made of steel or an organic fiber material coated with coating rubber and has a belt angle of from 0° or more to 10° or less as an absolute value. The one or the plurality of cords constituting the belt cover 253 is wound around the outer circumferential surfaces of the cross belts 251 and 252 multiple times in a spiral pattern in the tire circumferential direction, thus disposing the belt cover 253 layered outside the cross belts 251 and 252 in the tire radial direction.

A carcass 20 that internally includes radial ply cords is continuously disposed inward of the belt layer 25 in the tire radial direction and on the tire equatorial plane CL side of the sidewall portions 4. The carcass 20 has a single layer structure formed of one carcass ply, and is disposed across the pair of bead portions 10. That is, the one carcass 20 is bridged across the bead cores 11 and 11, which are disposed on both sides in the tire lateral direction, in a toroidal shape, thus constituting a backbone of the pneumatic tire 1.

Specifically, the carcass 20 is disposed from one bead portion 10 among the bead portions 10 located on both sides in the tire lateral direction to the other bead portion 10, and is folded back along the bead cores 11 from inward of the bead cores 11 in the tire lateral direction to outward in the tire lateral direction on the bead portions 10 so as to wrap around the bead cores 11 and the bead fillers 12. The carcass 20 thus includes a folded up portion 22, a part folded back from inward of the bead core 11 in the tire lateral direction to outward in the tire lateral direction. The folded up portion 22 of the carcass 20 is disposed extending outward in the tire radial direction at a position outward of the bead core 11 in the tire radial direction, and stacked with a body portion 21, which is a part disposed across the pair of bead portions 10 in the carcass 20, from outward in the tire lateral direction. The bead filler 12 is disposed in a region surrounded by the bead core 11, the body portion 21 and the folded up portion 22 of the carcass 20 outward of the bead core 11 in the tire radial direction.

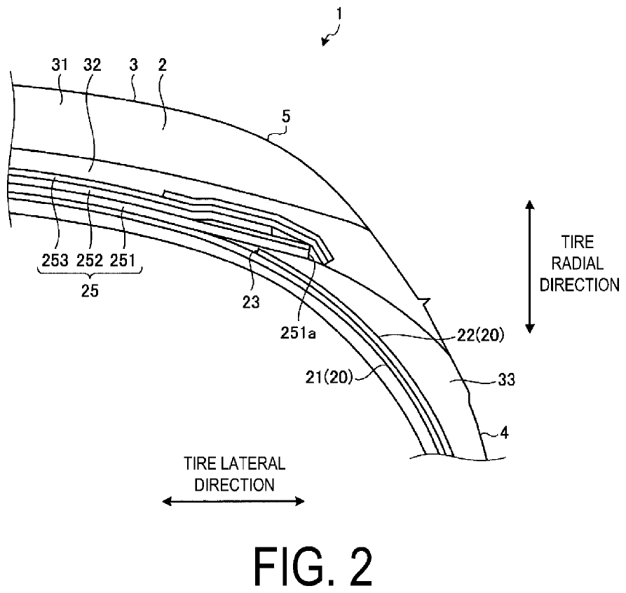

In comparison of a periphery length of the entire carcass 20 with a periphery length of the folded up portion 22 in a meridian cross-section of the pneumatic tire 1, the carcass 20 including the folded up portion 22 has (periphery length of the folded up portion 22/periphery length of the entire carcass 20) in a range from 0.20 or more to 0.35 or less. The periphery length of the entire carcass 20 in this case refers to the entire length of the carcass 20 in the direction along the carcass 20 including the two folded up portions 22 and body portions 21 in the meridian cross-section. The periphery length of the folded up portion 22 refers to the entire length of the folded up portion 22 in the direction along the folded up portion 22 between an end portion inward of the folded up portion 22 in the tire radial direction and an end portion 23 (see FIG. 2) outward of the folded up portion 22 in the tire radial direction.

The carcass ply of the carcass 20 is made by coating a plurality of carcass cords made of steel or an organic fiber material, such as aramid, nylon, polyester, rayon, and the like, with coating rubber and performing a rolling process on the carcass cords, and has a carcass angle as an inclination angle of the carcass cords with respect to the tire circumferential direction of 85° or more to 95° or less as an absolute value. In addition, the carcass cord has a wire diameter, which is a diameter of the carcass cord, in a range from 1100T/2 or more to 1670T/2 or less, and the cord count of the carcass cords per 50 mm in the direction in which the carcass cords are arranged is in a range from 45 or more to 55 or less.

A rim cushion rubber 34 constituting a contact surface of the bead portion 10 to a rim flange is disposed inward in the tire radial direction and outward in the tire lateral direction of the bead core 11 in the bead portion 10 and the folded up portion 22 of the carcass 20. An innerliner 35, as an air penetration preventing layer is disposed in an inner surface of the pneumatic tire 1. The innerliner 35 is formed inside the carcass 20 or an inner side of this carcass 20 in the pneumatic tire 1 along the carcass 20.

FIG. 2 is a detailed view of A of FIG. 1. In the carcass 20, the end portion 23 of the folded up portion 22 is disposed in a region inward of the belt layer 25 in the tire radial direction and inward of the belt layer 25 in the tire lateral direction. Specifically, the folded up portion 22, which is disposed extending outward in the tire radial direction from the bead portion 10 side, extends up to the vicinity of the belt layer 25, and the end portion 23 of the folded up portion 22 outward in the tire radial direction enters between the body portion 21 of the carcass 20 and the belt layer 25 in the vicinity of the belt layer 25. In other words, the end portion 23 of the folded up portion 22 of the carcass 20 is located between the cross belt 251, which is located innermost in the tire radial direction among the plurality of cross belts 251 and 252 included in the belt layer 25, and the body portion 21 of the carcass 20, and is located further inward in the tire lateral direction than the end portion 251a of the cross belt 251 in the tire lateral direction. Thus, in the carcass 20, the end portion 23 of the folded up portion 22 is sandwiched between the body portion 21 of the carcass 20 and the belt layer 25 in the tire radial direction.

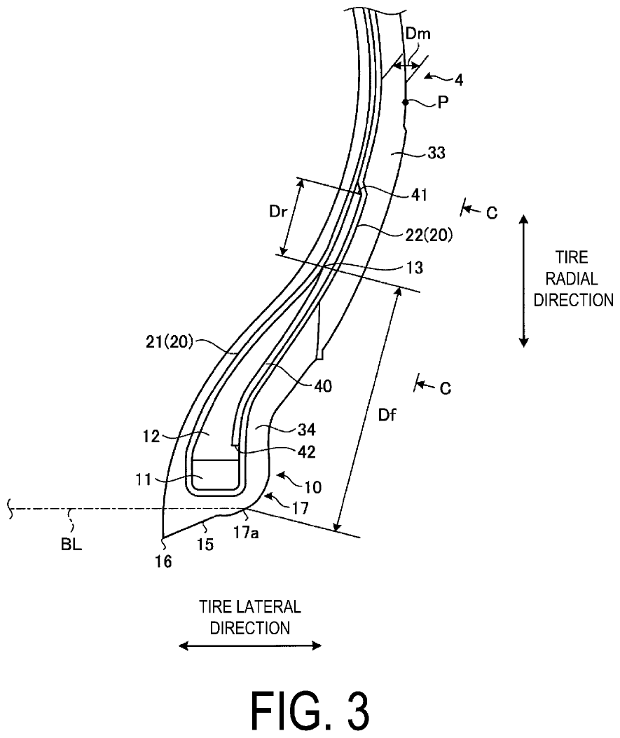

FIG. 3 is a detailed view of B of FIG. 1. The bead portion 10 includes a bead base 15. The bead base 15 is a surface inward of the bead portion 10 in the tire radial direction and is formed to be inclined with respect to a tire rotation axis in a direction widening outward in the tire radial direction from inward toward outward in the tire lateral direction. The bead base 15 has an end portion inward in the tire lateral direction provided as a bead toe 16, the innermost end of the bead portion, which is the innermost end portion in the tire radial direction of the bead portion 10. Additionally, the bead base 15 has an end portion outward in the tire lateral direction as a bead heel portion 17 formed into a curved surface projecting toward the surface side of the pneumatic tire 1. In other words, the bead base 15 and the outer surface of the pneumatic tire 1 in the tire lateral direction are connected with the bead heel portion 17, which is formed in an arcuate shape in the meridian cross-section view of the pneumatic tire 1.

In the bead filler 12, a distance Df between an outer end portion 13 and the bead heel portion 17 of the bead portion 10 in the tire radial direction is in a range from 20% or more to 40% or less of a tire cross-sectional height Hs. A measuring point of the distance Df on the bead heel portion 17 side in this case is an intersection point 17a between the bead heel portion 17 and the rim base line BL in a case where the distance between the pair of bead portions 10 in the tire lateral direction is a distance in a state where the pneumatic tire 1 is mounted on the specified rim. Accordingly, the distance Df is strictly the distance between the outer end portion 13 of the bead filler 12 in the tire radial direction and the intersection point 17a between the bead heel portion 17 and the rim base line BL.

The tire cross-sectional height Hs is a distance in the tire radial direction between a part of the tread portion 2 located outermost in the tire radial direction and the rim base line BL. That is, the tire cross-sectional height Hs refers to one-half of a difference between a tire outer diameter and a rim diameter in a case where the pneumatic tire 1 is mounted on the specified rim, specified internal pressure is inflated, and a load is not applied to the pneumatic tire 1, the unloaded state. The distance Df between the outer end portion 13 of the bead filler 12 and the bead heel portion 17 thus specified is preferably 40 mm or more to 50 mm or less.

The bead filler 12 preferably has a cross-sectional area in the meridian cross-section of the pneumatic tire 1 in a range from 110 mm² or more to 160 mm² or less, and the tire cross-sectional height Hs is preferably in a range from 110 mm or more to 170 mm or less. Furthermore, the pneumatic tire 1 according to the present embodiment preferably has an aspect ratio of 55 or more.

Additionally, a reinforcing layer 40 is disposed between the folded up portion 22 of the carcass 20 and the bead filler 12. The reinforcing layer 40 has an outer end portion 41 in the tire radial direction located further outward in the tire radial direction than the outer end portion 13 of the bead filler 12 in the tire radial direction, and further inward in the tire radial direction than the position of the tire maximum width position P in the tire radial direction. Additionally, the reinforcing layer 40 has an inner end portion 42 in the tire radial direction located further outward than the bead core 11 in the tire radial direction.

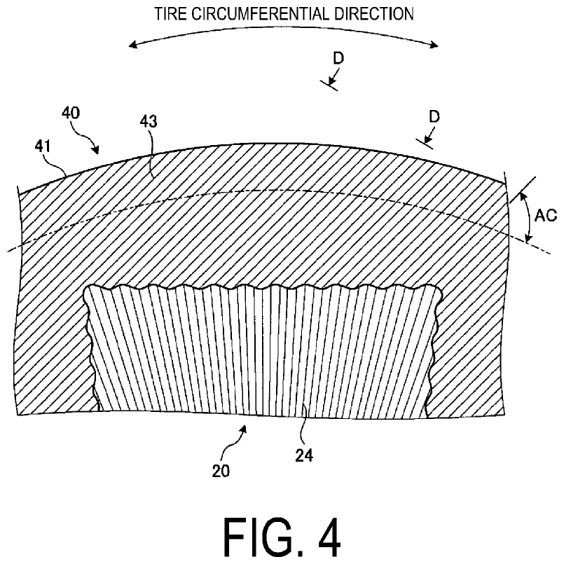

In other words, in a range where the bead filler 12 is located in the tire radial direction, the reinforcing layer 40 is sandwiched between the bead filler 12 and the folded up portion 22 of the carcass 20 from both sides in the tire lateral direction. Additionally, the reinforcing layer 40 is sandwiched between the body portion 21 of the carcass 20 and the folded up portion 22 of the carcass 20 from both sides in the tire lateral direction at a position outward from the bead filler 12 in the tire radial direction. Note that a distance Dr between the outer end portion 41 of the reinforcing layer 40 in the tire radial direction and the outer end portion 13 of the bead filler 12 in the tire radial direction is preferably in a range from 5 mm or more to 15 mm or less. FIG. 4 is an explanatory diagram of the carcass 20 and the reinforcing layer 40 as viewed in the C-C direction of FIG. 3. The reinforcing layer 40 includes reinforcing cords 43 made of steel and is configured by coating the plurality of reinforcing cords 43 with coating rubber and performing a rolling process on the reinforcing cords 43. The reinforcing cord 43 has an inclination angle AC with respect to the tire circumferential direction in a range from 15° or more to 25° or less. Thus, the reinforcing cords 43 are disposed so as to intersect with carcass cords 24 provided with the carcass 20. The reinforcing cords 43 are preferably disposed so as to intersect with the carcass cords 24 in a range from 65° or more to 75° or less.

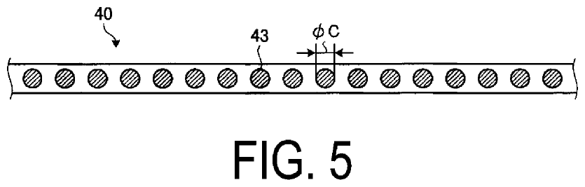

FIG. 5 is a view taken along line D-D of FIG. 4 in the direction of the arrows. The reinforcing cord 43 has a wire diameter ϕC in a range from 0.20 mm or more to 0.30 mm or less. The reinforcing layer 40 has a cord count of the reinforcing cords 43 per 50 mm in the direction orthogonal to the extension direction of the reinforcing cords 43, that is, in the direction in which the reinforcing cords 43 are arranged, in a range from 35 or more to 45 or less.

The pneumatic tire 1 according to the present embodiment is mainly used for a vehicle referred to as Sport Utility Vehicle (SUV) having both high traveling properties and comfort. To allow transmission of a large driving force to a road surface and ensure steering stability, most tires mounted on the SUV have comparatively large outer diameters. To mount the pneumatic tire 1 used for such a vehicle on the vehicle, a rim wheel is fitted to the bead portions 10, and the pneumatic tire 1 mounted to the rim wheel and inflated is mounted on the vehicle.

When the vehicle to which the pneumatic tires 1 are mounted runs, these pneumatic tires 1 rotate while the tread surfaces 3 located at the bottom in the tread surfaces 3 come into contact with the road surface. The vehicle transmits the driving force and a braking force to the road surface through a frictional force between the tread surface 3 and the road surface and generates a turning force to run. For example, in the transmission of the driving force to the road surface, power generated by a motor such as an engine provided with the vehicle is transmitted to the rim wheel, transmitted from the rim wheel to the bead portions 10, and then is transmitted to the pneumatic tire 1.

Thus, loads in various directions act on the respective portions of the pneumatic tire 1 in use, and these loads are received by a pressure of inflated air and the carcass 20, which is disposed as the backbone of the pneumatic tire 1. For example, the load acting in the tire radial direction between the tread portion 2 and the bead portion 10 caused by a weight of the vehicle and recesses and protrusions on the road surface is mainly received by the pressure of inflated air and the carcass 20. Thus, since the carcass 20 needs to receive the load acting on the pneumatic tire 1, the conventional pneumatic tires 1 mounted on the SUVs often include a plurality of the carcasses 20, and, for example, the conventional pneumatic tire 1 includes the two stacked carcasses 20.

In contrast, in the pneumatic tire 1 according to the present embodiment, only one carcass 20 is disposed. This reduces the entire mass of the carcass 20, thus ensuring reducing the mass of the pneumatic tire 1.

Note that the use of the one carcass 20 reduces members to ensure strength, so rigidity of the carcass 20 as a whole usually decreases. Meanwhile, in the present embodiment, the end portion 23 of the folded up portion 22 of the carcass 20 is disposed in the region inward of the belt layer 25 in the tire radial direction and inward of the belt layer 25 in the tire lateral direction. Thus, both ends of the folded up portion 22 of the carcass 20 in the tire radial direction are fixed, thus being usable as a member ensuring strength, and the folded up portion 22 is disposed between the tread portion 2 and the bead portion 10 along the sidewall portion 4, so the rigidity of the sidewall portion 4 can be ensured.

Moreover, the reinforcing layer 40 is disposed between the folded up portion 22 of the carcass 20 and the bead filler 12, and has the outer end portion 41 located further outward than the outer end portion 13 of the bead filler 12 in the tire radial direction and further inward in the tire radial direction than the position of the tire maximum width position P in the tire radial direction, thus ensuring appropriately improving the rigidity of the sidewall portion 4. Thus, even when a large load is applied on the pneumatic tire 1, the sidewall portion 4 whose rigidity is ensured by the folded up portion 22 and the reinforcing layer 40 can appropriately receive the load. This allows improving steering stability and also allows ensuring ride comfort performance.

Additionally, in the bead filler 12, since the distance Df between the outer end portion 13 of the bead filler 12 and the bead heel portion 17 of the bead portion 10 is in a range from 20% or more to 40% or less of the tire cross-sectional height Hs, the rigidity of the sidewall portion 4 can be appropriately improved with the bead filler 12 as well. In other words, in a case where the distance Df between the outer end portion 13 of the bead filler 12 and the bead heel portion 17 is less than 20% of the tire cross-sectional height Hs, the size of the bead filler 12 in the tire radial direction is too small, so the effect of improving the rigidity of the sidewall portion 4 by the bead filler 12 is not appropriately exhibited possibly. Additionally, in a case where the distance Df between the outer end portion 13 of the bead filler 12 and the bead heel portion 17 exceeds 40% of the tire cross-sectional height Hs, since the size of the bead filler 12 in the tire radial direction is too large, the rigidity of the sidewall portion 4 possibly becomes too high by the bead filler 12. In this case, ride comfort performance is possibly deteriorated due to the excessively high rigidity of the sidewall portion 4. In contrast, in a case where the distance Df between the outer end portion 13 of the bead filler 12 and the bead heel portion 17 is in a range from 20% or more to 40% or less of the tire cross-sectional height Hs, the bead filler 12 can provide the effect of improving the rigidity of the sidewall portion 4 to the extent that ride comfort performance is not deteriorated.

In the pneumatic tire 1 according to the present embodiment, thus configuring the one carcass 20 allows light weight and also improvement in the rigidity of the sidewall portion 4 allows improving steering stability; however, typically, improving the rigidity of the sidewall portion 4 is likely to worsen a rolling resistance. In contrast, in the pneumatic tire 1 according to the present embodiment, the sidewall portion 4 is formed of the side rubber 33 having the tan δ at 60° C. in the range from 0.04 or more to 0.10 or less, and the low-heat-generating rubber having the tan δ lower than that of the rubber usually used for the sidewall portion 4 is used. Accordingly, while the rigidity of the sidewall portion 4 is improved, the rolling resistance can be reduced. As a result, while the light mass and reduction in rolling resistance are achieved, steering stability can be improved.

Additionally, in the reinforcing layer 40, the distance Dr between the outer end portion 41 of the reinforcing layer 40 and the outer end portion 13 of the bead filler 12 is in the range from 5 mm or more to 15 mm or less, so the rigidity of the sidewall portion 4 can be appropriately improved more reliably. In other words, in a case where the distance Dr between the outer end portion 41 of the reinforcing layer 40 and the outer end portion 13 of the bead filler 12 is less than 5 mm, a range in which the reinforcing layer 40 is disposed is not so large and a range reinforced by the reinforcing layer 40 is not so large. Accordingly, even when the reinforcing layer 40 is disposed, the rigidity of the sidewall portion 4 is possibly difficult to be improved. In this case, even when the reinforcing layer 40 is disposed, there is a possibility that steering stability is difficult to be effectively improved. Additionally, in a case where the distance Dr between the outer end portion 41 of the reinforcing layer 40 and the outer end portion 13 of the bead filler 12 exceeds 15 mm, the range in which the reinforcing layer 40 is disposed possibly becomes too large. In this case, the range reinforced by the reinforcing layer 40 is increased, so the rigidity of the sidewall portion 4 becomes too high, and ride comfort performance is possibly difficult to be ensured.

In contrast, in a case where the distance Dr between the outer end portion 41 of the reinforcing layer 40 and the outer end portion 13 of the bead filler 12 is in a range from 5 mm or more to 15 mm or less, the range in which the reinforcing layer 40 is disposed can be the appropriate range more reliably. Accordingly, in reinforcement of the sidewall portion 4 by the reinforcing layer 40, the appropriate range can be reinforced more reliably, and the rigidity of the sidewall portion 4 can be appropriately improved more reliably. As a result, while ride comfort performance is ensured more reliably, steering stability can be ensured.

Additionally, the reinforcing layer 40 includes the reinforcing cords 43 made of steel, the wire diameter ϕC of the reinforcing cord 43 is in the range from 0.20 mm or more to 0.30 mm or less, and the cord count of the reinforcing cords 43 per 50 mm is in the range from 35 or more to 45 or less, so the rigidity of the sidewall portion 4 can be an appropriate size more reliably. In other words, the wire diameter ϕC of the reinforcing cord 43 of less than 0.20 mm or the cord count of the reinforcing cords 43 per 50 mm of less than 35 possibly makes it difficult to ensure the rigidity of the reinforcing layer 40 itself, and even when the reinforcing layer 40 is disposed, there may be a case where effectively increasing the rigidity of the sidewall portion 4 becomes difficult. In this case, effectively improving steering stability possibly becomes difficult. In addition, the wire diameter ϕC of the reinforcing cord 43 in excess of 0.30 mm or the cord count of the reinforcing cords 43 per 50 mm in excess of 45 possibly results in too high rigidity of the reinforcing layer 40 itself, and disposing the reinforcing layer 40 possibly makes the rigidity of the sidewall portion 4 too high. In this case, ride comfort performance is possibly difficult to be ensured.

In contrast, in a case where the wire diameter ϕC of the reinforcing cord 43 is in a range from 0.20 mm or more to 0.30 mm or less and the cord count of the reinforcing cords 43 per 50 mm is in a range from 35 or more to or 45 or less, the rigidity of the reinforcing layer 40 itself can be the appropriate size, and disposing the reinforcing layer 40 allows configuring the rigidity of the sidewall portion 4 to be the appropriate size. As a result, while ride comfort performance is ensured more reliably, steering stability can be improved.

Moreover, since the cross-sectional area of the bead filler 12 in the meridian cross-section of the pneumatic tire 1 is in a range from 110 mm² or more to 160 mm² or less, the rigidity of the sidewall portion 4 can be the appropriate size more reliably. In other words, in a case where the cross-sectional area of the bead filler 12 is less than 110 mm², the cross-sectional area of the bead filler 12 is too small, so the effect of improving the rigidity of the sidewall portion 4 by the bead filler 12 is not appropriately exhibited possibly. Additionally, the cross-sectional area of the bead filler 12 in excess of 160 mm² increases the cross-sectional area of the bead filler 12 too much, and the rigidity of the sidewall portion 4 possibly becomes too high by the bead filler 12. In this case, ride comfort performance is possibly deteriorated due to the excessively high rigidity of the sidewall portion 4.

In contrast, in a case where the cross-sectional area of the bead filler 12 is in a range from 110 mm² or more to 160 mm² or less, the bead filler 12 can provide the effect of improving the rigidity of the sidewall portion 4 to the extent that ride comfort performance is not deteriorated. As a result, while ride comfort performance is ensured more reliably, steering stability can be improved.

Additionally, in a case where the distance Df between the outer end portion 13 of the bead filler 12 and the bead heel portion 17 is 40 mm or more to 50 mm or less, the rigidity of the sidewall portion 4 can be the appropriate size more reliably. In other words, in a case where the distance Df between the outer end portion 13 of the bead filler 12 and the bead heel portion 17 is less than 40 mm, the size of the bead filler 12 in the tire radial direction is too small, so the effect of improving the rigidity of the sidewall portion 4 by the bead filler 12 is not appropriately exhibited possibly. Additionally, in a case where the distance Df between the outer end portion 13 of the bead filler 12 and the bead heel portion 17 exceeds 50 mm, since the size of the bead filler 12 in the tire radial direction is too large, the rigidity of the sidewall portion 4 possibly becomes too high by the bead filler 12. In this case, ride comfort performance is possibly deteriorated due to the excessively high rigidity of the sidewall portion 4.

In contrast, in a case where the distance Df between the outer end portion 13 of the bead filler 12 and the bead heel portion 17 is in a range from 40 mm or more to 50 mm or less, the bead filler 12 can provide the effect of improving the rigidity of the sidewall portion 4 to the extent that ride comfort performance is not deteriorated. As a result, while ride comfort performance is ensured more reliably, steering stability can be improved.

Further, since the base rubber 32 of the tread portion 2 has JIS hardness at 20° C. in the range from 75 or more to 81 or less and the tan δ at 60° C. in the range from 0.14 or more to 0.22 or less, while heat build-up during tire rolling is suppressed, the rigidity of the tread portion 2 can be the appropriate size. In other words, in a case where the rubber hardness of the base rubber 32 measured at 20° C. is less than 75, the rigidity of the tread portion 2 becomes too low, possibly making it difficult to ensure steering stability. In a case where the rubber hardness of the base rubber 32 measured at 20° C. exceeds 81, the rigidity of the tread portion 2 becomes too high, possibly making it difficult to ensure ride comfort performance. In a case where the tan δ of the base rubber 32 at 60° C. is less than 0.14, although heat build-up during tire rolling can be suppressed, ensuring the rubber hardness of the base rubber 32 becomes difficult, possibly making it difficult to ensure steering stability. The tan δ of the base rubber 32 at 60° C. in excess of 0.22 makes it difficult to effectively suppress heat build-up during tire rolling, and possibly rolling resistance is difficult to be reduced.

In contrast, in a case where the base rubber 32 has rubber hardness in the range from 75 or more to 81 or less and the tan δ at 60° C. in the range from 0.14 or more to 0.22 or less, while heat build-up during tire rolling is suppressed, the rigidity of the tread portion 2 can be the appropriate size. Consequently, while rolling resistance is reduced more reliably and riding comfort performance is ensured, steering stability can be improved.

In addition, since the minimum value Dm of the thickness of the side rubber 33 is in the range of 1.0 mm≤Dm≤3.5 mm, the mass of the sidewall portion 4 can be more reliably reduced while cut resistance performance is maintained. In other words, in a case where the minimum value Dm of the thickness of the side rubber 33 is less than 1.0 mm, the thickness of the side rubber 33 is too thin. Accordingly, cut resistance performance, which is a performance to protect an internal structure such that the inner structure such as the carcass 20 is not damaged when the sidewall portion 4 is rubbed against a curb or the like, is possibly deteriorated. Additionally, in a case where the minimum value Dm of the thickness of the side rubber 33 exceeds 3.5 mm, the thickness of the side rubber 33 becomes too thick, so the mass of the sidewall portion 4 is likely to increase, and this possibly makes it difficult to reduce the mass of the pneumatic tire 1.

In contrast, since the minimum value Dm of the thickness of the side rubber 33 is in the range of 1.0 mm≤Dm≤3.5 mm, while the thickness of the side rubber 33 that can maintain cut resistance performance is ensured, the mass of the sidewall portion 4 can be reduced more reliably. As a result, while cut resistance performance is ensured, the light mass of the pneumatic tire 1 can be achieved more reliably.

In a case where the tire cross-sectional height Hs is in a range from 110 mm or more to 170 mm or less and the aspect ratio is 55 or more, the carcass 20 in the meridian cross-section of the pneumatic tire 1 lengthens. Accordingly, compared with the two carcasses 20, the one carcass 20 can significantly reduce its mass. Additionally, since the disposed region of the sidewall portion 4 in the tire radial direction also increases, the effect of reduction in rolling resistance brought by the use of rubber having the tan δ at 60° C. in a range from 0.04 or more to 0.10 or less for the side rubber 33 increases. Additionally, since the disposed region of the sidewall portion 4 in the tire radial direction increases, the effect of improving steering stability brought by stacking the end portion 23 of the carcass 20 with the belt layer 25, disposing the reinforcing layer 40, and setting the distance Df in the range from 20% or more to 40% or less of the tire cross-sectional height Hs can be further remarkably obtained. As a result, while the light mass and reduction in rolling resistance are achieved, the effect of improving steering stability can be further remarkably obtained.

Note that while the pneumatic tire 1 according to the above-described embodiment includes the reinforcing layer 40 including the reinforcing cords 43 made of steel, the reinforcing layer 40 needs not include the reinforcing cords 43. The reinforcing layer 40 not including the reinforcing cords 43 may be made of rubber having JIS hardness at 20° C., that is, rubber hardness measured at 20° C. and indicated by JIS-A hardness compliant with JIS K6253 in a range from 85 or more to 95 or less and the tan δ at 60° C. in a range from 0.12 or more to 0.20 or less. Configuring the reinforcing layer 40 using the rubber having such a physical property value allows appropriately improving the rigidity of the sidewall portion 4 without the use of the reinforcing cords 43 and allows suppressing rolling resistance. This allows improving steering stability and ride comfort performance while achieving reduction in rolling resistance.

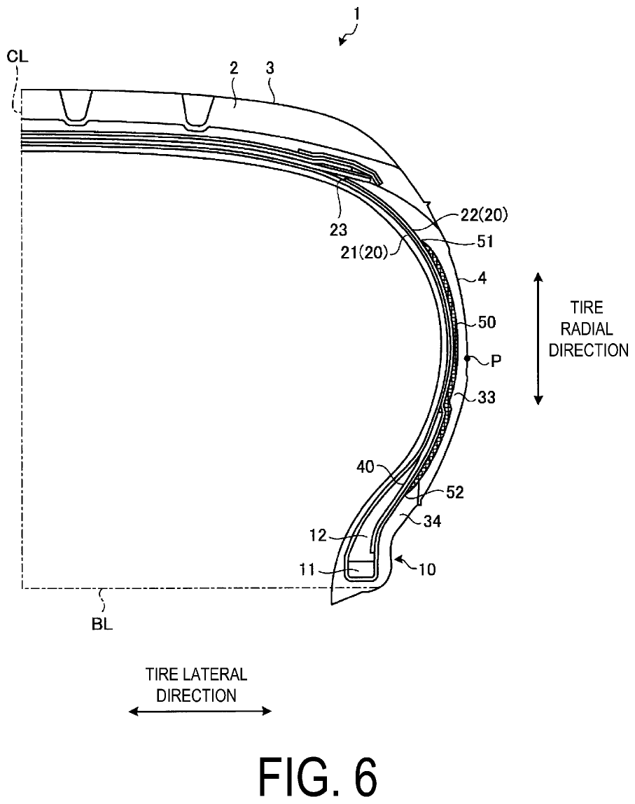

Additionally, the pneumatic tire 1 according to the above-described embodiment may be provided with a reinforcing member different from the reinforcing layer 40. FIGS. 6 to 8 are modified examples of the pneumatic tire 1 according to the embodiment and are explanatory diagrams of a side reinforcing layer 50. For example, as illustrated in FIGS. 6 to 8, as the reinforcing member different from the reinforcing layer 40, the side reinforcing layer 50 may be disposed between the side rubber 33 or the rim cushion rubber 34 and the folded up portion 22 of the carcass 20. The side reinforcing layer 50 is preferably configured of rubber having JIS hardness at 20° C. in a range from 70 or more to 85 or less and tan δ at 60° C. in a range from 0.06 or more to 0.12 or less, and is preferably formed at a thickness in a range from 0.5 mm or more to 2.0 mm or less.

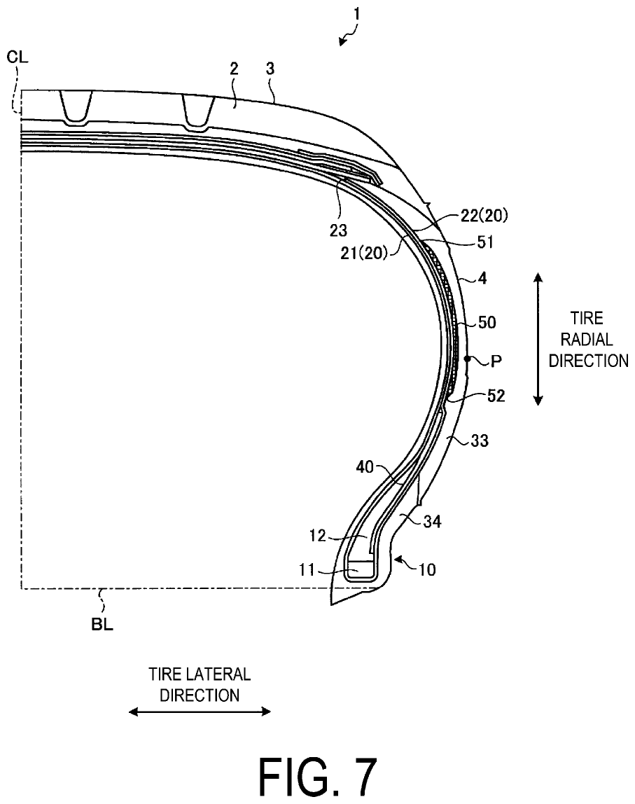

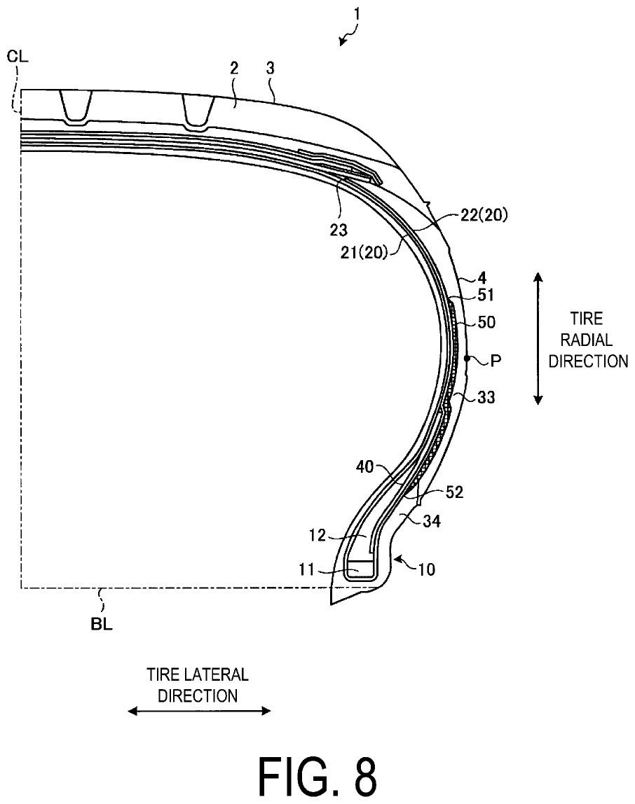

Additionally, it is only required that a position where the side reinforcing layer 50 is disposed is disposed at a position including the tire maximum width position P. For example, as illustrated in FIG. 6, the side reinforcing layer 50 may be disposed such that an outer end portion 51 in the tire radial direction is located in the vicinity of the tread portion 2, and an inner end portion 52 of the side reinforcing layer 50 in the tire radial direction is located between the folded up portion 22 of the carcass 20 and the rim cushion rubber 34. Alternatively, as illustrated in FIG. 7, the side reinforcing layer 50 may be disposed such that the outer end portion 51 is located in the vicinity of the tread portion 2 and the inner end portion 52 is located in the vicinity of the tire maximum width position P and at a position slightly inward of the tire maximum width position P in the tire radial direction. Alternatively, as illustrated in FIG. 8, the side reinforcing layer 50 may be disposed such that the inner end portion 52 is located between the folded up portion 22 of the carcass 20 and the rim cushion rubber 34 and the outer end portion 51 is located in the vicinity of the tire maximum width position P and at a position slightly outward of the tire maximum width position P in the tire radial direction. In other words, it is only required that the side reinforcing layer 50 is disposed such that the outer end portion 51 is located further inward than the end portion 23 of the folded up portion 22 of the carcass 20 in the tire radial direction, the outer end portion 51 is located outward of the tire maximum width position Pin the tire radial direction, and the inner end portion 52 is located inward of the tire maximum width position P in the tire radial direction.

By thus disposing the side reinforcing layer 50 made of rubber harder than the rubber hardness of the side rubber 33 with a thickness in a range from 0.5 mm or more to 2.0 mm or less at the position including the tire maximum width position P, the rigidity of the sidewall portion 4 can be ensured more easily. Accordingly, to configure the rigidity of the pneumatic tire 1 to be a desired size, the size can be adjusted using the side reinforcing layer 50, thus ensuing the rigidity with the desired size more reliably. Additionally, by configuring the side reinforcing layer 50 with rubber having the tan δ at 60° C. in the range from 0.06 or more to 0.12 or less, the increase in rolling resistance can be suppressed in a case where the side reinforcing layer 50 is disposed. This allows improving steering stability and ride comfort performance while achieving reduction in rolling resistance more reliably.

### Examples

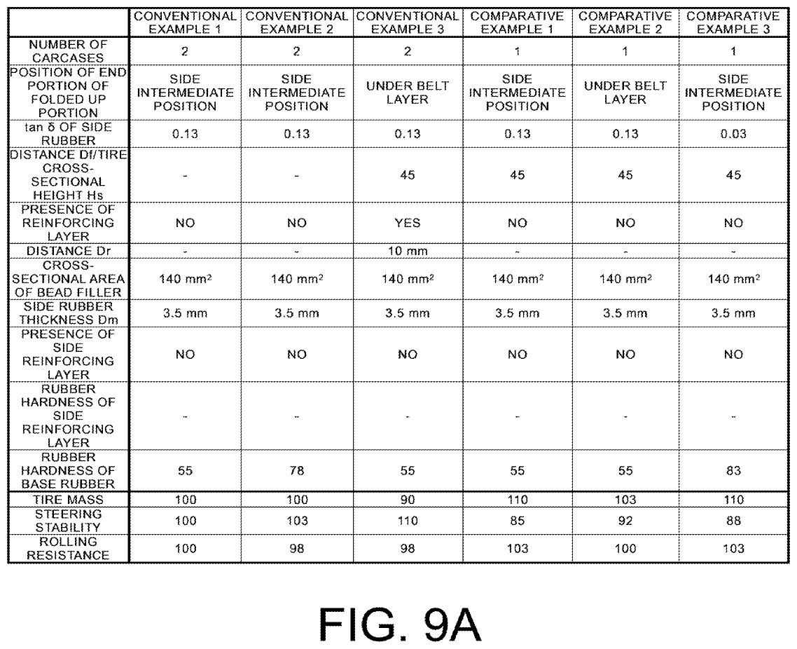

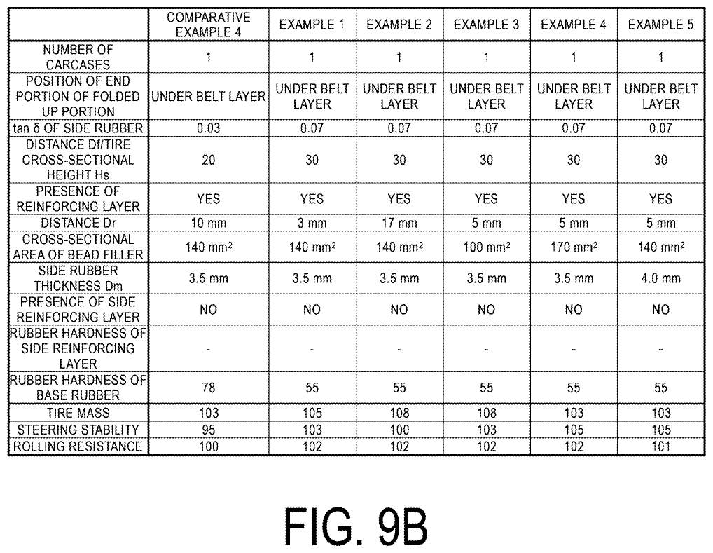

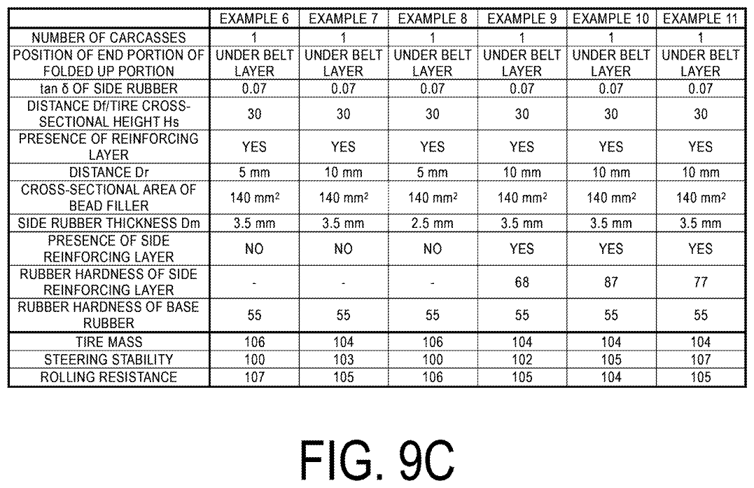

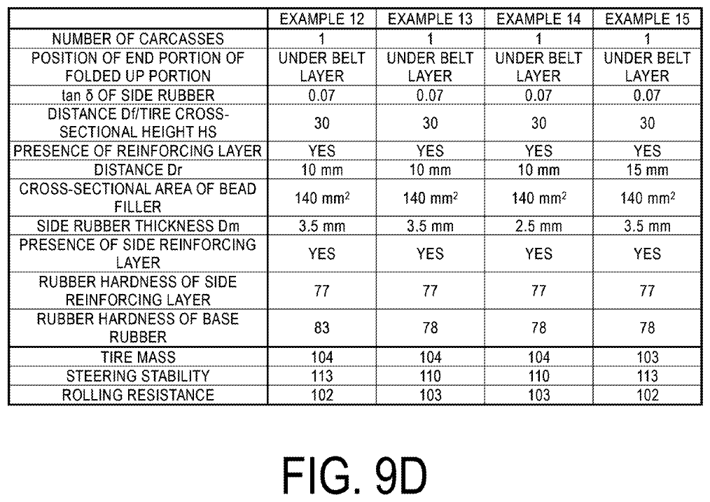

FIGS. 9A to 9D are tables describing results of performance tests of pneumatic tires. The following will describe evaluation tests on performances conducted on pneumatic tires of conventional examples and comparative examples and the pneumatic tires 1 according to the embodiments of the present technology regarding the above-described pneumatic tire 1. The performance evaluation test was conducted on tests for tire mass, which is the mass of the pneumatic tire 1, steering stability, and rolling resistance.

The performance evaluation test was conducted using the pneumatic tires 1 with nominal tire size specified by JATMA of 235/55R19 101V. Regarding the tire mass, an evaluation method for each test item expressed a weight of one test tire as an index value with Conventional Example 1 described later being assigned the value of 100. The smaller value means the lighter weight per tire and indicates excellent tire mass from an aspect of light weight.

Regarding steering stability, the test tires were mounted rim wheels of JATMA standard rims, specified internal pressures were inflated, the test tires were mounted on all wheels of test vehicles, four-wheel-drive SUVs with engine displacement of 2400 cc. Then, a test driver run the test vehicles on a test course to perform sensory evaluation on steering stability during running. The steering stability is expressed as a grade with Conventional Example 1 described later being assigned the value of 100. The larger value indicates that the performance of steering stability is excellent.

Regarding rolling resistance, the test tires were mounted on the rim wheels of the JATMA standard rims, the specified internal pressures were inflated, and an indoor drum testing machine (drum diameter: 1707 mm) was used to calculate rolling resistance coefficient with conditions compliant with ISO (International Standards Organisation) 28580, load of 6.47 kN and a speed of 80 km/hour. The result is expressed as an index value of a reciprocal of the rolling resistance coefficient with Conventional Example 1 described later being assigned the value of 100. A large index value indicates a low rolling resistance.

The evaluation test was conducted on 22 types of pneumatic tires: pneumatic tires of Conventional Examples 1 to 3, which are examples of the conventional pneumatic tires 1, Examples 1 to 15, which are the pneumatic tires 1 according to the embodiments of the present technology, and pneumatic tires of Comparative Examples 1 to 4, which are pneumatic tires for comparison with the pneumatic tires 1 according to the embodiments of present technology. Among these pneumatic tires 1, all of the pneumatic tires of Conventional Examples 1 to 3 include the two carcasses 20, and the end portions 23 of the folded up portions 22 of the carcasses 20 are located in the vicinity of the tire maximum width positions P, that is, in the vicinity of intermediate positions between the belt layers 25 and the bead portions 10 in the sidewall portions 4. Additionally, the pneumatic tires of Conventional Examples 1 to 3 do not include the reinforcing layers 40, and the side rubbers 33 have the tan δ at 60° C. outside a range from 0.04 or more to 0.10 or less. Additionally, although the pneumatic tires of Comparative Examples 1 to 4 include the one carcass 20, the side rubbers 33 have the tan δ at 60° C. outside the range from 0.04 or more to 0.10 or less.

In contrast, all of Examples 1 to 15, which are examples of the pneumatic tires 1 according to the embodiments of the present technology, include the one carcass 20, the end portions 23 of the folded up portions 22 of the carcasses 20 are located under the belt layers 25, that is, in regions inward of the belt layers 25 in the tire radial direction and inward of the belt layers 25 in the tire lateral direction. All of the pneumatic tires 1 according to Examples 1 to 15 include the reinforcing layers 40 and have the tan δ at 60° C. of the side rubbers 33 in a range from 0.04 or more to 0.10 or less. Additionally, the pneumatic tires 1 according to Examples 1 to 15 differ in the respective distance Dr between the outer end portion 41 of the reinforcing layer 40 and the outer end portion 13 of the bead filler 12, cross-sectional area of the bead filler 12, minimum value Dm of the thickness of the side rubber 33, presence and rubber hardness of the side reinforcing layer 50, and rubber hardness of the base rubber 32.

As described in FIGS. 9A to 9D, the results of conducting the evaluation tests using the pneumatic tires 1 have found that the pneumatic tires 1 of Examples 1 to 15 can achieve the light mass of tire and improve steering stability and further can reduce rolling resistance compared with those of Conventional Examples 1 to 3 and Comparative Examples 1 to 4. In other words, the pneumatic tires 1 according to Examples 1 to 15 can improve steering stability while achieving the light mass and reduction in rolling resistance.

1. A pneumatic tire comprising:
a belt layer disposed inward of a tread portion in a tire radial direction;
a pair of sidewall portions disposed on both sides of a tire equatorial plane in a tire lateral direction;
a pair of bead portions disposed inward of the pair of the sidewall portions in the tire lateral direction, the pair of bead portions comprising bead cores formed into annular shapes;
bead fillers disposed outward of the bead cores in the tire radial direction;
one carcass disposed across the pair of bead portions, the one carcass having a folded up portion, the folded up portion being folded back outward of the bead core in the tire lateral direction from inward in the tire lateral direction; and
a reinforcing layer disposed between the folded up portion of the carcass and the bead filler;
the folded up portion of the carcass having an end portion disposed in a region inward of the belt layer in the tire radial direction and inward of the belt layer in the tire lateral direction;
the bead fillers having outer end portions in the tire radial direction having a distance from bead heel portions of the bead portions in a range from 20% or more to 40% or less of a tire cross-sectional height;
the reinforcing layer having an outer end portion in the tire radial direction located further outward in the tire radial direction than the outer end portion of the bead filler in the tire radial direction and further inward in the tire radial direction than a position of a tire maximum width position in the tire radial direction, the reinforcing layer having an inner end portion in the tire radial direction located further outward than the bead core in the tire radial direction; and
the sidewall portions made of a side rubber having tan δ at 60° C. in a range from 0.04 or more to 0.10 or less.

2. The pneumatic tire according to claim 1, wherein in the reinforcing layer, the outer end portion of the reinforcing layer has a distance from the outer end portion of the bead filler in a range from 5 mm or more to 15 mm or less.

3. The pneumatic tire according to claim 1, wherein
the reinforcing layer comprises a reinforcing cord made of a steel,
the reinforcing cord has a wire diameter in a range from 0.20 mm or more to 0.30 mm or less, and
the reinforcing cord in the reinforcing layer has a cord count per 50 mm in a range from 35 or more to 45 or less.

4. The pneumatic tire according to claim 1, wherein the reinforcing layer is made of a rubber, and the rubber has JIS hardness at 20° C. in a range from 85 or more to 95 or less and tan δ at 60° C. in a range from 0.14 or more to 0.22 or less.

5. The pneumatic tire according to claim 1, wherein the bead filler has a cross-sectional area in a meridian cross-section of the pneumatic tire in a range from 110 mm² or more to 160 mm² or less.

6. The pneumatic tire according to claim 1, wherein
the tread portion comprises a cap rubber forming a tread surface and a base rubber, and the base rubber is located inward of the cap rubber in the tire radial direction, and
the base rubber has JIS hardness at 20° C. in a range from 75 or more to 81 or less and tan δ at 60° C. in a range from 0.14 or more to 0.22 or less.

7. The pneumatic tire according to claim 1, wherein the side rubber has a minimum value Dm of a thickness in a range of 1.0 mm≤Dm≤3.5 mm.

8. The pneumatic tire according to claim 1, wherein
between the side rubber or a rim cushion rubber and the folded up portion of the carcass, a side reinforcing layer is disposed, and the side reinforcing layer is made of a rubber having JIS hardness at 20° C. in a range from 70 or more to 85 or less and tan δ at 60° C. in a range from 0.06 or more to 0.12 or less, and
the side reinforcing layer is formed at a thickness in a range from 0.5 mm or more to 2.0 mm or less, and the side reinforcing layer is disposed at a position comprising the tire maximum width position.

9. The pneumatic tire according to claim 1, wherein the tire cross-sectional height is in a range from 110 mm or more to 170 mm or less, and an aspect ratio is 55 or more.

10. The pneumatic tire according to claim 2, wherein
the reinforcing layer comprises a reinforcing cord made of a steel,
the reinforcing cord has a wire diameter in a range from 0.20 mm or more to 0.30 mm or less, and
the reinforcing cord in the reinforcing layer has a cord count per 50 mm in a range from 35 or more to 45 or less.

11. The pneumatic tire according to claim 2, wherein the reinforcing layer is made of a rubber, and the rubber has JIS hardness at 20° C. in a range from 85 or more to 95 or less and tan δ at 60° C. in a range from 0.14 or more to 0.22 or less.

12. The pneumatic tire according to claim 10, wherein the bead filler has a cross-sectional area in a meridian cross-section of the pneumatic tire in a range from 110 mm² or more to 160 mm² or less.

13. The pneumatic tire according to claim 12, wherein
the tread portion comprises a cap rubber forming a tread surface and a base rubber, and the base rubber is located inward of the cap rubber in the tire radial direction, and
the base rubber has JIS hardness at 20° C. in a range from 75 or more to 81 or less and tan δ at 60° C. in a range from 0.14 or more to 0.22 or less.

14. The pneumatic tire according to claim 13, wherein the side rubber has a minimum value Dm of a thickness in a range of 1.0 mm≤Dm≤3.5 mm.

15. The pneumatic tire according to claim 14, wherein
between the side rubber or a rim cushion rubber and the folded up portion of the carcass, a side reinforcing layer is disposed, and the side reinforcing layer is made of a rubber having JIS hardness at 20° C. in a range from 70 or more to 85 or less and tan δ at 60° C. in a range from 0.06 or more to 0.12 or less, and
the side reinforcing layer is formed at a thickness in a range from 0.5 mm or more to 2.0 mm or less, and the side reinforcing layer is disposed at a position comprising the tire maximum width position.

16. The pneumatic tire according to claim 15, wherein the tire cross-sectional height is in a range from 110 mm or more to 170 mm or less, and an aspect ratio is 55 or more.
